(19) United States
(12) Patent Application Publication
(10) Pub. No.: US 2011/0305498 A1
(43) Pub. Date: Dec. 15, 2011

(54) NOVELTY SPLIT GOLF BALL WIRELESS MEASUREMENT DEVICE

(76) Inventor: Damian De La Rosa, Martinez, CA (US)

(21) Appl. No.: 12/796,924

(22) Filed: Jun. 9, 2010

(51) Int. Cl. B43K 29/08; G01S 13/08; G01C 3/08

(52) U.S. Cl. 401/195; 356/4.01; 342/125

(57) ABSTRACT

A novelty golf ball-shaped measuring device is described. The golf ball assembly is split into two halves, one having a wireless receiver and display while the other has a transponder that is activated by an RF transmitter. Distance between the halves is calculated using the received wireless signal and is shown on the display. A pen-shaped device is also described in which the cap houses the display, and the pen barrel houses the transponder. Other sport and household item-shaped devices that split into multiple parts to measure and display distances are envisioned.

### CROSS-REFERENCES TO RELATED APPLICATIONS

NOT APPLICABLE

### BACKGROUND

1. Field of the Art

Novelty distance measuring devices and methods for manufacturing and using the measuring devices are disclosed. Specifically, novelty golf ball-shaped and household item-shaped devices that separate into at least two parts with means to wirelessly measure the distance between the parts are disclosed.

2. Discussion of the Related Art

In the game of golf, a player whose golf ball is farthest from the currently-played hole traditionally proceeds first before the other players. To determine whose golf ball is farthest from the hole, players typically eyeball whose ball is farthest. It is generally easy to estimate on the fairway because there is only one direction to go, that direction being toward the green and flagpole denoting the location of the hole on the green. However, it becomes more difficult nearer to or on the green as golf balls generally land in different radial directions from the hole and, therefore, their relative distances are not easily compared.

In a variation of golf sometimes referred to as “closest to the pin,” or “closest to the hole,” the goal is for a player to land his or her ball closest to the hole on his or her first shot, or “tee shot.” (The “pin” is an affectionate name for the flagpole.) In charity tournaments and other amateur golf tourneys, multiple groups of golfers record their distances from the pin as they play the hole. Sometimes, the distances are recorded on a pad of paper that is left near the green to which it pertains. After the last player has played the hole, the player with the closest distance overall is then recognized with points, an award, etc. Accurately measuring the distance that each ball lands from the pin can therefore be quite important for a fair tournament.

In some tournaments, a measuring tape is left near the green to assist players in measuring their golf balls' distances from the pin. However, it sometimes can be difficult to measure the distance from a grassy hole in the ground to a ball using a measuring tape. Common measuring tapes have a small metal bend at the 0″ end for use in wrapping around a rigid corner, such as the corner of a two-by-four. However, the small metal bend does not have anywhere to wrap around in the center of an empty golf hole. If the metal lip is wrapped over the grassy edge of the hole, the metal can dig into the grass and disrupt the measurement, or worse, tear the thatch. At the ball end, it can sometimes be difficult to measure to the center of the golf ball because it is spherical and can be measured from the nearest tangential edge or the center of the ball. Different players can have different measurement techniques and end up with different measurements for the same ball. As is infamously known in the game of golf, less scrupulous players sometimes skew the measurements of their balls so as to be closer to the pin. Furthermore, a measuring tape can accidentally (or intentionally) move the ball as one conducts a measurement.

U.S. Pat. No. 3,834,030 (issued Sep. 10, 1974) to Hanson discloses a measuring tape having a post and lipped shelf that fits snugly within a golf hole at the 0″ end, thus solving some of the problems associated with measuring at the golf hole end. However, the post and shelf are relatively bulky to transport, the shelf being at least 4¼″ (108 mm) in diameter, which is the diameter of a regulation golf hole.

There is a need for better measurement devices for determining the distance of a golf ball to a hole, and there is a need for more convenient distance measuring devices in general.

### BRIEF SUMMARY

Embodiments in accordance with the present disclosure relate to novelty measuring devices that separate into at least two parts with means to wirelessly measure the distance between the parts. Form factors include golf ball-shaped devices for use in the game of golf and variations of golf, such as “closest to the pin.” Form factors also include household item-shaped devices, such as pens and kitchen magnets, for wireless measurements by contractors, homeowners, and other users. Wireless distance measurement technologies include radio frequency (RF), infrared (IR), and laser technologies. One of the separated parts can have a digital display that shows the distance between it and another part. Alternatively or additionally, a speaker can audibly speak the distance, or a simple set of light emitting diode (LED) indicators can indicate relative distances. A transmitter can be co-located with the display, located in the remote part, or located off-board in neither part in a bi-static configuration.

An embodiment in accordance with the present disclosure relates to a novelty measurement apparatus, including a first partial sphere housing, a second partial sphere housing, means for releasably coupling the first to the second housing such that a coupled assembly of the partial sphere housings forms a complete sphere, a wireless receiver coupled to the first housing, the receiver adapted to receive a wireless signal from the second housing, and a circuit operatively coupled to the receiver, the circuit adapted to determine a distance between the first and second housings using the wireless signal.

The coupled assembly can be approximately 42.67 millimeters (1.680 inches), or 40 millimeters, in diameter to approximate the size of a regulation golf ball or weigh approximately 45.93 grams (1.620 ounces), or 46 grams, to approximate the weight of a regulation golf ball. Each of the spherical parts can have dimples to simulate the appearance of a golf ball, either miniature, regulation-sized, or novelty-large. An embodiment can further include a transmitter coupled to the first housing, the transmitter enabled to transmit the wireless signal. The circuit can be enabled to determine the distance by measuring a time delay between a signal transmitted from the transmitter and a received reflection or “ping” off of a component coupled to the second housing. Another embodiment can further include a transmitter coupled to the second housing, the transmitter enabled to transmit the wireless signal, in which the circuit is enabled to determine the distance by measuring an intensity of a signal received from the transmitter by the receiver.

A switch can be operatively coupled to the circuit, the switch adapted to activate the circuit when the first and second housings are de-coupled from each other. The means for releasably coupling the first to the second housing can be electrically connected to the circuit and be operative to receive the wireless signal, thereby serving as an antenna. For example, a metal screw shaft that holds the halves together can also serve as an antenna.

An embodiment relates to a golf ball-shaped novelty measurement apparatus, including a spherical housing, the housing having a first portion and a second portion, the first and second portions releasably coupled to each other, a wireless receiver coupled to the first housing portion, the receiver adapted to receive a wireless signal from the second housing portion, and a circuit operatively coupled to the receiver, the circuit adapted to determine a distance between the first and second housing portions using the wireless signal. A display adapted to display the determined distance can be included.

An embodiment relates to a pen-shaped or other writing instrument-shaped novelty measurement apparatus, including a barrel having a shape that is graspable in the hand of a person, a cap adapted to releasably connect to the barrel, a wireless receiver coupled to one of the barrel and cap, the receiver adapted to receive a wireless signal from the other one of the barrel and cap, and a circuit operatively coupled to the receiver, the circuit adapted to determine a distance between the first and second housings using the wireless signal. The apparatus can include a display adapted to display the determined distance.

An embodiment relates to a method of manufacturing a golf ball-shaped novelty measurement apparatus, comprising: providing a golf ball, separating the golf ball into a first portion and a second portion, attaching a component to the second portion, the component adapted to emit or reflect a wireless signal when pinged by a wireless transmitter; attaching a receiver, circuit, and indicator to the first portion, the receiver adapted to receive the wireless signal, the circuit adapted to determine a distance between the first and second portions using the received wireless signal, and the indicator adapted to indicate the determined distance. The embodiment can use a new or used golf ball.

The method can further include hogging out or otherwise removing an amount of material equal to the mass of the attached receiver, circuit, indicator, and other components, thereby ending up with the weight of the original golf ball. The first and second portions can be halves, or one portion can be larger than the other. The method can further include co-locating the transmitter with the receiver in the first portion, and the component attached to the second portion can be an active transponder powered by a battery.

The method can further include powering on the transmitter and receiver, pinging the component such that it emits or reflects the wireless signal, receiving the wireless signal, determining the distance between the first and second portions, and indicating the determined distance using the indicator. The method can further include calibrating the distance between the portions when they are releasably connected with each other.

A further understanding of the nature and the advantages of the embodiments disclosed and suggested herein may be realized by reference to the remaining portions of the specification and the attached drawings.

### BRIEF DESCRIPTION OF THE DRAWINGS

FIG. 1A illustrates a golf ball-shaped measurement device in accordance with an embodiment.

FIG. 1B illustrates the device of FIG. 1A, somewhat separated.

FIG. 1C illustrates the device of FIG. 1A, separated farther than shown in FIG. 1B.

FIG. 2 illustrates a golf ball-shaped measurement device with an internal display in accordance with an embodiment.

FIG. 3 illustrates a golf ball-shaped measurement device with a simple indicator in accordance with an embodiment.

FIG. 4 illustrates a pair of golf ball-shaped devices on a green in accordance with an embodiment.

FIG. 5 illustrates a transmitter co-located with the receiver in accordance with an embodiment.

FIG. 6 illustrates a transmitter located remotely from the receiver in accordance with an embodiment.

FIG. 7 illustrates transmitters located off-board the device in accordance with an embodiment.

FIG. 8 illustrates a measurement device with a bayonet connector and speaker in accordance with an embodiment.

FIG. 9 illustrates a measurement device with a serpentine attachment area in accordance with an embodiment.

FIG. 10 illustrates a measurement device with WIFFLE® ball-shaped, perforated spherical surfaces in accordance with an embodiment.

FIG. 11 illustrates a measurement device with differently sized portions and a pin and recess connection in accordance with an embodiment.

FIG. 12A illustrates a pen-shaped measurement device in accordance with an embodiment.

FIG. 12B illustrates the device of FIG. 12A, separated.

FIG. 13 illustrates a pen-shaped measurement device measuring distance in accordance with an embodiment.

FIG. 14A illustrates a yo-yo shaped measurement device measuring distance in accordance with an embodiment.

FIG. 14B illustrates the device of FIG. 14A, separated.

FIG. 15 is a flowchart illustrating a process in accordance with an embodiment.

The figures will now be used to illustrate different embodiments in accordance with the invention. The figures are specific examples of embodiments and should not be interpreted as limiting embodiments, but rather exemplary forms and procedures.

### DETAILED DESCRIPTION

Novelty wireless distance measurement devices that separate into at least two parts are described, including those that are shaped like golf balls, pens, kitchen magnets, and other sport and household items. Wireless distance measurement technologies include radio frequency (RF), infrared (IR), and/or laser technologies. A display, speaker, or other indicator on one of the parts can indicate the distance between the parts. A transmitter can be co-located with the indicator, located in the remote part, or located off-board.

Technical advantages of a golf ball-shaped/sized device for use in golf over the prior art are many. Prior art systems, such as that described by Hanson (cited above) are relatively bulky to tote along and require aligning and fitting a contraption over a golf hole. The size of Hanson's contraption makes it discernable from a distance, which may incur unwanted remarks from other golfers. The seeming complexity of the device, with a reel of measuring tape hanging from a 4 1/2″ diameter plate, may intimidate or otherwise discourage golfers from using it. Furthermore, the lipped shelf may matt down the grassy circumferential edge of the golf hole and disturb the natural play lines. Different users can use the measuring tape differently: one may measure to the closest edge of their ball and another may measure to the center of his ball. It can be difficult, given parallax between the spherical ball and the flat measuring tape, for an over-the-shoulder observer to verify the measurement by another golfer. In contrast to the prior art, an embodiment such as a golf ball-shaped/sized device can be relatively small and portable. It can blend in with other golf balls so that other golfers are less likely to see its use. The golf ball-shaped/sized device can be stored in cup holders, sleeves, carrying cases, and a plethora of other paraphernalia sold for storing golf balls. A two-part embodiment can be easy to use, and the parts can attach neatly and securely to one another when not in use. One part can fit neatly into the golf hole cup on a green without disturbing the grass edge surrounding the hole. The other part can replace the owner's golf ball on the green in the exact position of the other ball so that others can verify it is properly placed. A digital readout or audible speaker allows an observer to verify the measured distance without parallax. A wireless system offers a repeatable method of measuring distance. The golf ball-shaped devices can be imprinted with logos, slogans, and other marketing graphics as is commonly done for golf balls in the industry.

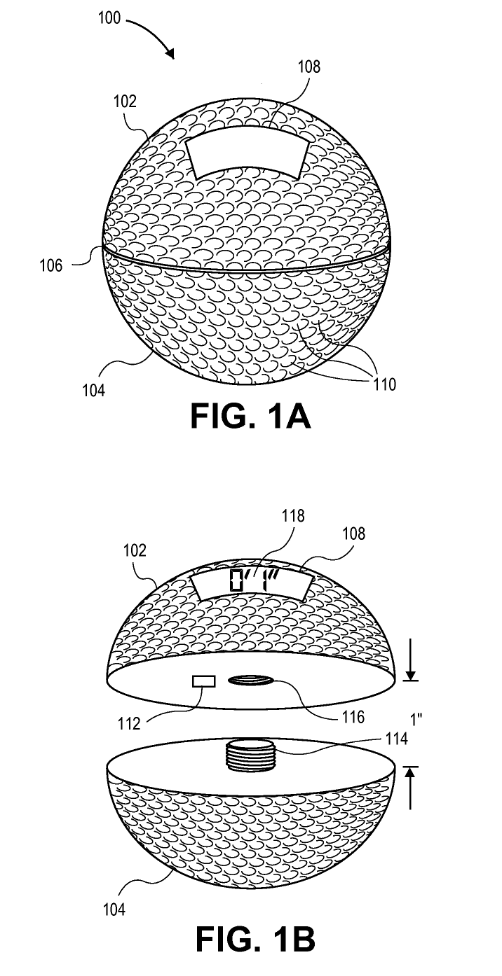

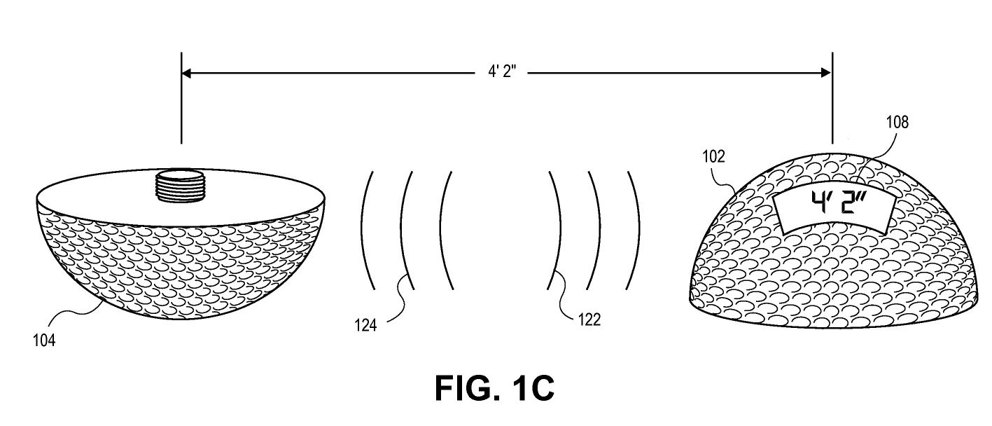

FIG. 1A illustrates a golf ball-shaped measurement apparatus in accordance with an embodiment. Spherical housing assembly 100 has upper hemisphere 102 and lower hemisphere 104 with seam 106 in between. Liquid crystal display 108 is on the outside of the ball and is turned off in the figure. Dimples 110 cover the outer surface of the hemispheres like a golf ball.

Assembly 100 can be approximately 42.67 millimeters (1.680 inches), or 40 millimeters, in diameter to approximate the size of a regulation golf ball as approved by the Royal and Ancient Golf Club of St. Andrews (R&A) and/or the United States Golf Association (USGA). Assembly 100 can be made from an actual golf ball, new or recycled.

“Approximately” includes values within 5%, 8%, 10%, 15%, or more of the nominal value and/or as otherwise known in the art. For example, an assembly that is 45 millimeters in diameter is approximately 40 millimeters in diameter.

FIG. 1B illustrates hemispheres 102 and 104 slightly separated by an inch. Hemisphere 102, having female screw threads 116 (e.g. a nut), has been unscrewed from hemisphere 104, which has male threaded rod 114. Electrical switch 112 has activated, allowing electricity from a battery (not shown in the figure) to power liquid crystal display 108. Liquid crystal display 108 shows the measurement 0′ 1″ as segmented digits 118, representing that the hemispheres' centers are zero feet, 1 inch apart.

FIG. 1C illustrates hemispheres 102 and 104 separated farther than they were in FIG. 1B and placed horizontally with respect to each other. A transmitter (not shown in the figure) in hemisphere 104 transmits radio frequency (RF) signal 122 to ping hemisphere 104. E.g., a reflective circuit (not shown in the figure) in hemisphere 104 receives and alters RF signal 122 and reflects or transmits it back as altered RF signal 124. The distance is calculated and shown on liquid crystal display 108. In other embodiments, the display can be a light emitting diode (LED), organic LED, or other display technologies as known in the art.

The transmitter and/or receiver in hemisphere 102 can use metal nut 116 (FIG. 1B) as an antenna, and the reflective circuit in hemisphere 104 can use metal screw 114 (FIG. 1B) as an antenna. Suitable wireless RF components for distance measurements include those designed and/or manufactured by Pulse Engineering, Inc. of San Diego, Calif., United States of America.

Electromagnetic radiation frequencies other than radio frequencies can be used, including infrared (IR) or visible wavelengths using a laser. Sonic or ultrasonic sound frequencies can also be used instead of electromagnetic radiation to determine distance.

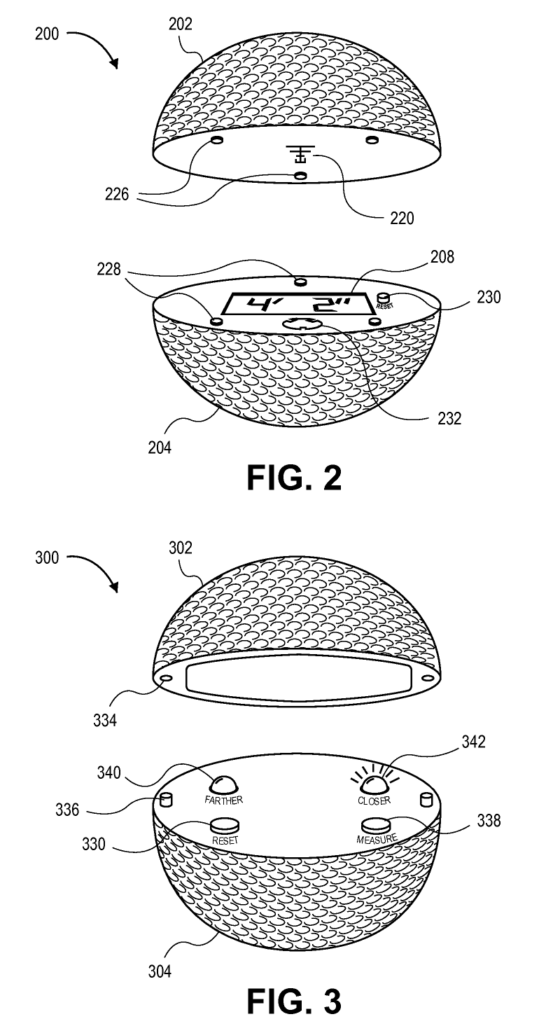

FIG. 2 illustrates a golf ball-shaped measurement device having a display inside and protected when assembly 200 is together. Upper hemisphere 202 has magnets 226 and antenna 220. Antenna 220 reflects or emits RF energy when pinged by a suitable transmitter.

Lower hemisphere 204 has magnets 228 with the same north-south orientation as magnets 226 so that the two hemispheres snap together when joined but are releasable from one another by simply pulling apart. Button 230 can be used for calibration, resetting, mode setting, or other functions. Battery compartment 232 can house a small wristwatch battery to power the display, transmitter (not shown in the figure), receiver (not shown in the figure), and other active components. A battery within battery compartment 232 can be rechargeable.

FIG. 3 illustrates a golf ball-shaped measurement device having simple indicators. Upper hemisphere 302 has recesses 334 that accept friction pegs. Lower hemisphere 304 has friction pegs 336 that mate into recesses 334 to lock the hemispheres together. Reset button 330 can be used to clear a measurement memory of the device. Pressing measure button 338 can store a distance measurement. Pressing measure button 338 again will compare a new measurement to the stored measurement, and LED indicators 340 and 342 can indicate whether the new measurement is farther or closer to the previous measurement, respectively.

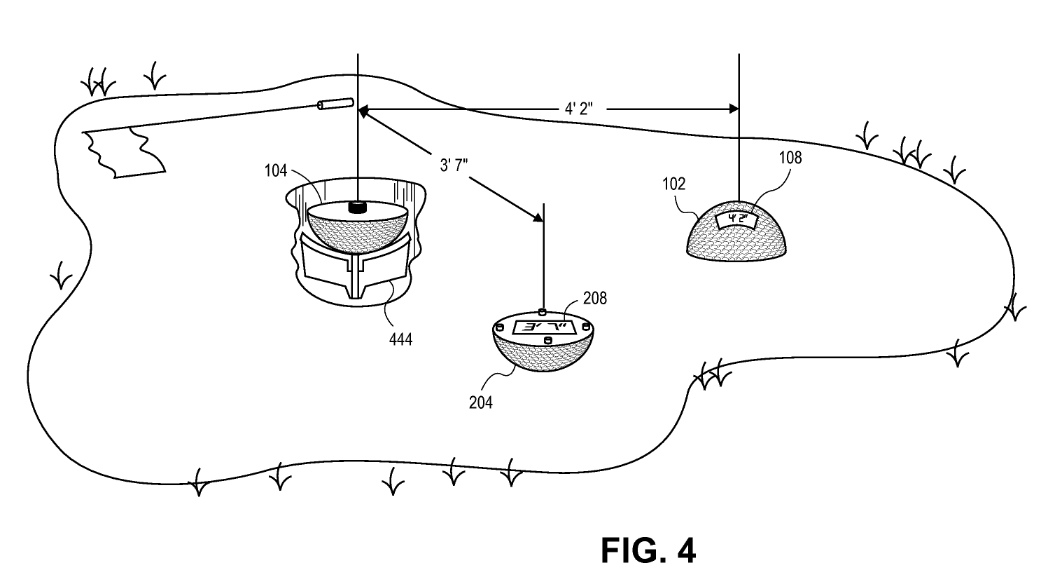

FIG. 4 illustrates a pair of golf ball-shaped devices in use on a golf green for a closest-to-the-pin game. Lower hemisphere 104 sits in cup 444, fitting where a golf ball would settle if it dropped into the hole. Lower hemisphere 104 can be weighted such that a player can nonchalantly flip it into the hole and it seeks to rest convex side down. Upper hemisphere 102 sits convex side up in a place where a player's golf ball had come to rest. Liquid crystal display 108 reads measurement 4′ 2″ to show the distance between the hemisphere's center and the center of lower hemisphere 104 in the cup.

Because the bottom of the golf hole cup is below the surface, there is a vertical component to the straight-line distance between hemispheres 102 and 104. The vertical component can be subtracted out if the depth of the cup is known beforehand or estimated. The depth of cups may be different between cup manufacturers but are often 4 inches deep. (Regulations merely require that the depth of cups be at least one inch below the surface.) That the center of hemisphere 102 rests prone, directly on the surface of the grass compensates for one radius of the golf ball (i.e. 0.84 inches). An additional vertical component can be subtracted.

Lower hemisphere 204 sits convex side down in a place where another player's golf ball had rested. Lower hemisphere 204, although not the same model as lower hemisphere 104 as indicated by the different means of attachment and display configuration, may still be able to ping the transponder in lower hemisphere 104 and calculate a distance therebetween in some embodiments. Liquid crystal display 208 indicates that the distance between lower hemisphere 104 and lower hemisphere 204 is 3′ 7″. Therefore, the golf ball that this hemisphere replaced was closer to the hole than the other ball.

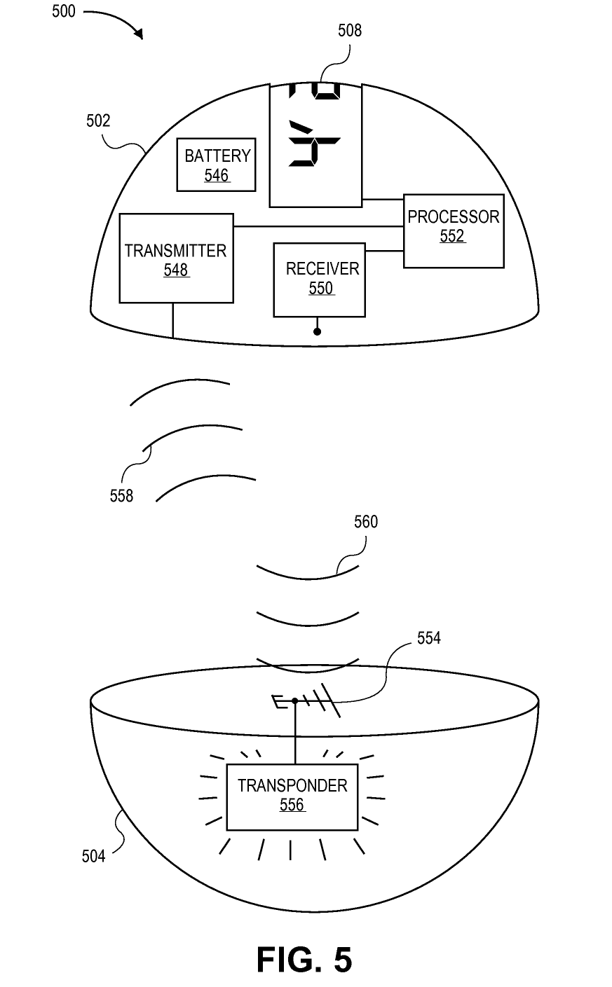

FIG. 5 illustrates measurement system 500 in accordance with an embodiment. Battery 546 powers components as necessary in portion 502. Processor 552 commands transmitter 548 to transmit RF waveform 558. Transponder 556 in portion 504 detects waveform 558 and emits RF signal 560, which may or may not be an altered reflection of waveform 558. Antenna 554 can be tuned for incoming waveform 558, outgoing RF signal 560, or a compromise between both. RF signal 560 is received by receiver 550. Receiver 550 feeds the received signal to processor 552.

A time delay between transmitted signal 558 and received RF signal 560 can indicate the distance between portions 502 and 504. For example, if the delay is 8.47 nanoseconds, then the distance is simply (delay)×(speed of light)÷2=(8.47×10⁻⁹ seconds)×(299,792,458 m/s)÷2=1.27 meters (4 feet, 2 inches). The division by 2 is in the equation because the signal has completed a round trip. Known time lag caused by circuitry, transponder 556, etc. can be subtracted out as necessary. Processor 552 then provides the resulting measurement, 4′ 2″, to display 508.

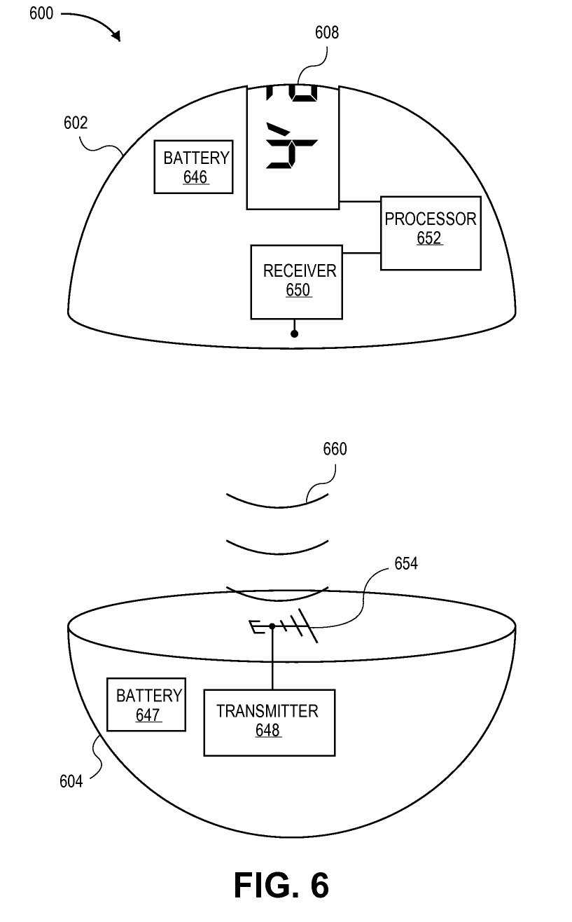

FIG. 6 illustrates measurement system 600 in accordance with an embodiment. Battery 646 powers components as necessary in upper portion 602. Battery 647 powers components as necessary in lower portion 604. Transmitter 648 and omnidirectional antenna 654 are calibrated to emit a predetermined intensity of electromagnetic energy in RF signal 660. Receiver 650 receives RF signal 660 and feeds it to processor 652. Processor 652 compares the received signal to the calibrated intensity. Using the inverse square law (1/r²) for intensity, the distance can be computed and displayed on display 608. Other attenuation schemes can be used for non-omnidirectional antennas.

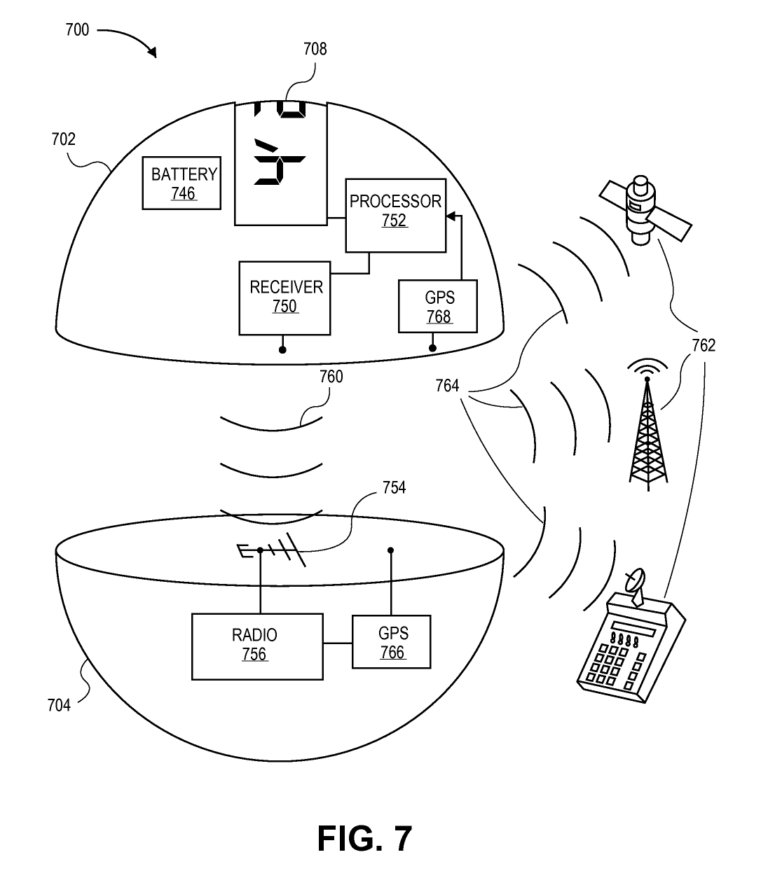

FIG. 7 illustrates measurement system 700 in accordance with an embodiment. Battery 746 powers proximally located components as necessary in portion 702. An off-board emitter, such as global positioning system (GPS) satellites, a fixed radio tower, or a portable transmitter, transmits geo-location waveform 764 in a GPS format. Geo-location waveform 764 is detected by GPS unit 766 in portion 704, and GPS unit 766 feeds position data to radio 756. Radio 756 transmits its position through antenna 754 in radio signal 760.

The radio formats used can be compatible with the wireless universal serial bus (wireless USB) format, Institute of Electrical and Electronics Engineers (IEEE) 802.11 format, BLUETOOTH® format, or other wireless formats as known in the art.

Receiver 750 receives radio signal 760 and feeds the position data to processor 752. Simultaneously, GPS unit 768 in portion 702 detects geo-location waveform 764 and determines its position. This ownship position is fed to processor 752 and compared with position data from portion 704. The difference in positions is displayed on display 708.

In an alternate embodiment from the geo-location techniques disclosed above, emitters 764 can send radar and timing information for a bi-static configuration. For example, waveform 764 may simply have a time code, and that time code is re-transmitted from radio 756. Comparison of the received time code in receiver 750 with the current time received by GPS unit 768 can indicate the time delay for signal 760 to travel from portion 704 to portion 702.

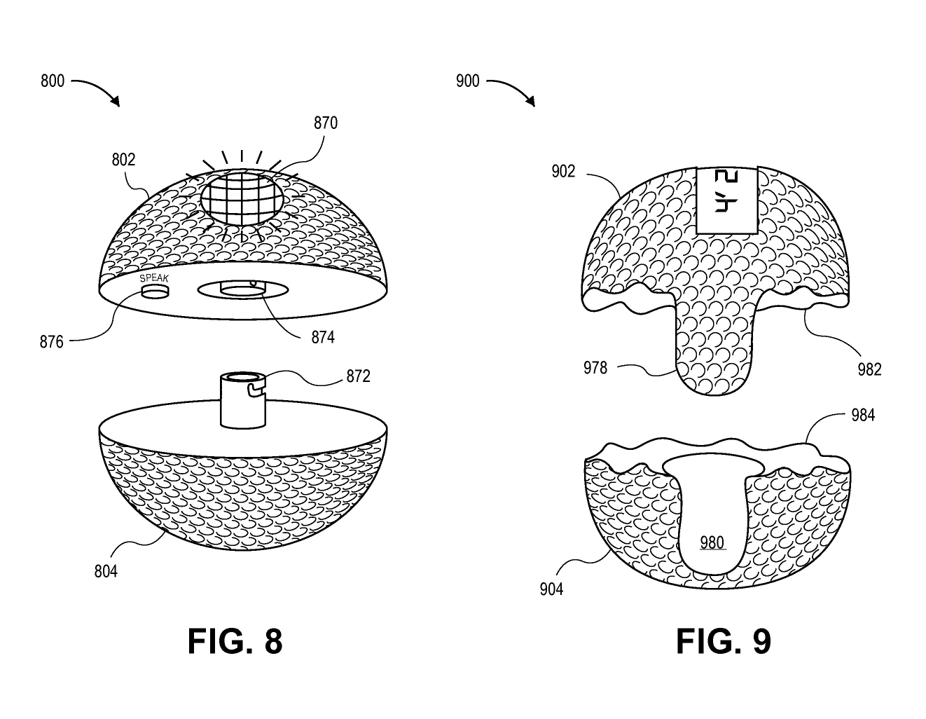

FIG. 8 illustrates a measurement device having a bayonet connector and speaker. Upper half 802 of device 800 has pin-side bayonet connector 874, and lower half 804 has L-slotted bayonet connector 872.

Speaker 870 can audibly speak, such as with an olde Scottish accent, the distance between the halves when button 876 is depressed, such as when the upper half is pressed on the ground. As an alternative, the speaker can emit a non-voice sound indicating that a previous measured distance was farther or shorter than the currently measured distance. For example, an upward chirp can indicate farther, and a downward chirp can indicate closer.

FIG. 9 illustrates a measurement device with a serpentine attachment area. Upper housing 902 of measurement system 900 has puzzle connector 978 that intimately conforms with recess 980 of lower housing 904 so that magnets, pins, snaps, suction cups, hook and loop fasteners (e.g. VELCRO®), pin and foam cushion, or other releasable joining means are unnecessary. Upper serpentine lip 982 of upper housing 902 conforms with lower serpentine lip 984 to better fasten the housings together when assembled. Puzzle connector 978 may be used as a handle so that housing 902 is easier to grasp, or it may hold a trigger button to switch modes on the display, etc.

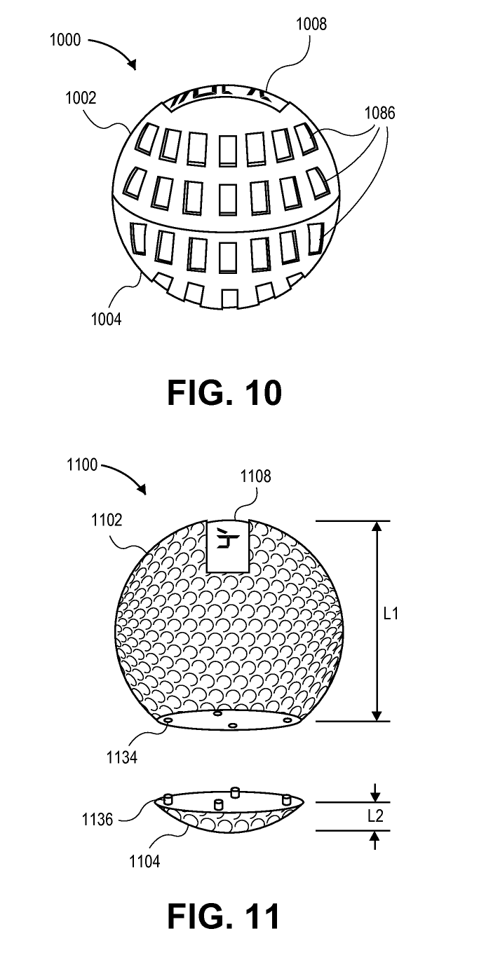

FIG. 10 illustrates a measurement device having perforations around the outside, such as those resembling WIFFLE® ball perforations. In the exemplary embodiment, upper half 1002 and lower half 1004 of measurement system 1000 both have perforations 1086; however, one side may be solid with no perforations. Perforations can improve cooling for components, reduce weight of the device, and make the outside surface more pliable so that the device can be stored in tight spaces.

FIG. 11 illustrates a golf ball-shaped measurement device with differently sized portions and pin and recess connections. Upper partial sphere 1102 of measurement system 1100 is the majority of the golf ball, having diameter fraction L1 of the sphere. Lower partial sphere 1104 has less material, having the remaining diameter fraction L2. Because upper partial sphere 1102 houses more components, such as display 1108, a receiver, battery, etc., than lower partial sphere 1104, which houses a transponder, upper partial sphere 1102 can have more volume to enclose the components in this configuration.

Recesses 1134 on upper housing 1102 dock with pins 1136, which protrude from lower partial sphere 1136. Friction between the pins and the recess walls keeps the partial spheres together as an assembly. Other shapes besides golf ball shapes can also be used for measurement devices around the house, work, and on the road.

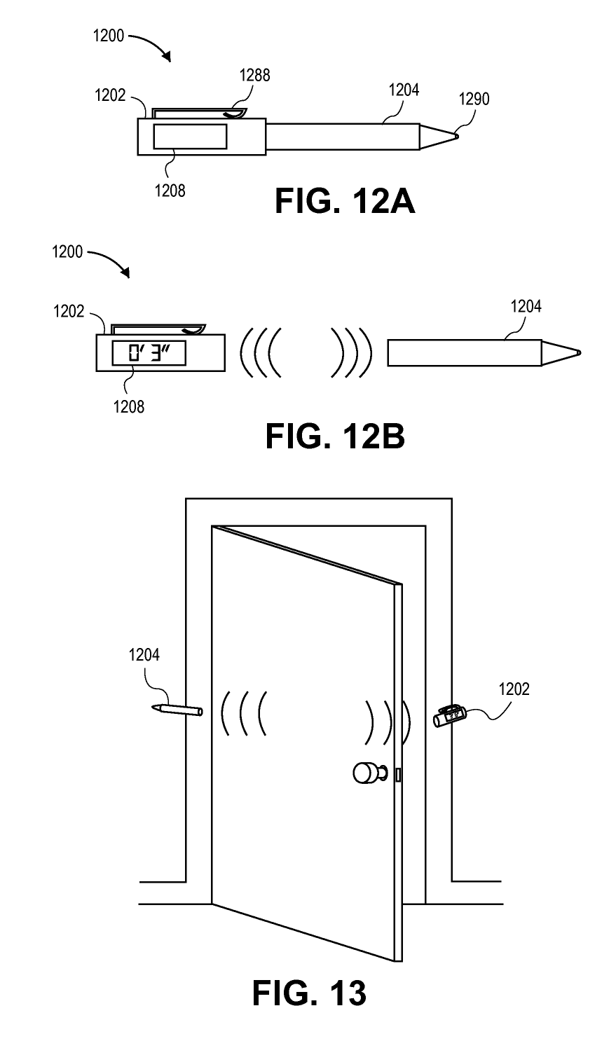

FIG. 12A illustrates a handy pen-shaped measurement device in accordance with an embodiment. Measurement system 1200 includes cap 1202 housing display 1208. Shirt pocket clip 1288 is optional and can include an antenna. A receiver and associated circuit feed distance data to display 1208.

Measurement system 1200 also includes barrel 1204, sized appropriately for grasping as a common pen or pencil. Barrel 1204 can have pen tip 1290 suitable for writing or otherwise applying ink or graphite to a surface such that measurement system 1200 can be used as a working pen or pencil.

FIG. 12B illustrates the cap 1202 and barrel 1204 of measurement system 1200 pulled apart. As similarly described above for the golf ball-shaped measurement system embodiments, measurement system 1200 displays the distance between the two parts and can be activated when pulled apart either automatically or manually.

FIG. 13 illustrates a use for the measurement system of FIGS. 12A and 12B. Cap 1202 and barrel 1204 are held at opposite sides of a door in order to give the user a measurement of the doorway width. This can be helpful for a contractor, handyman, resident, etc., in determining whether a large object, such as a sofa, will fit through the doorway.

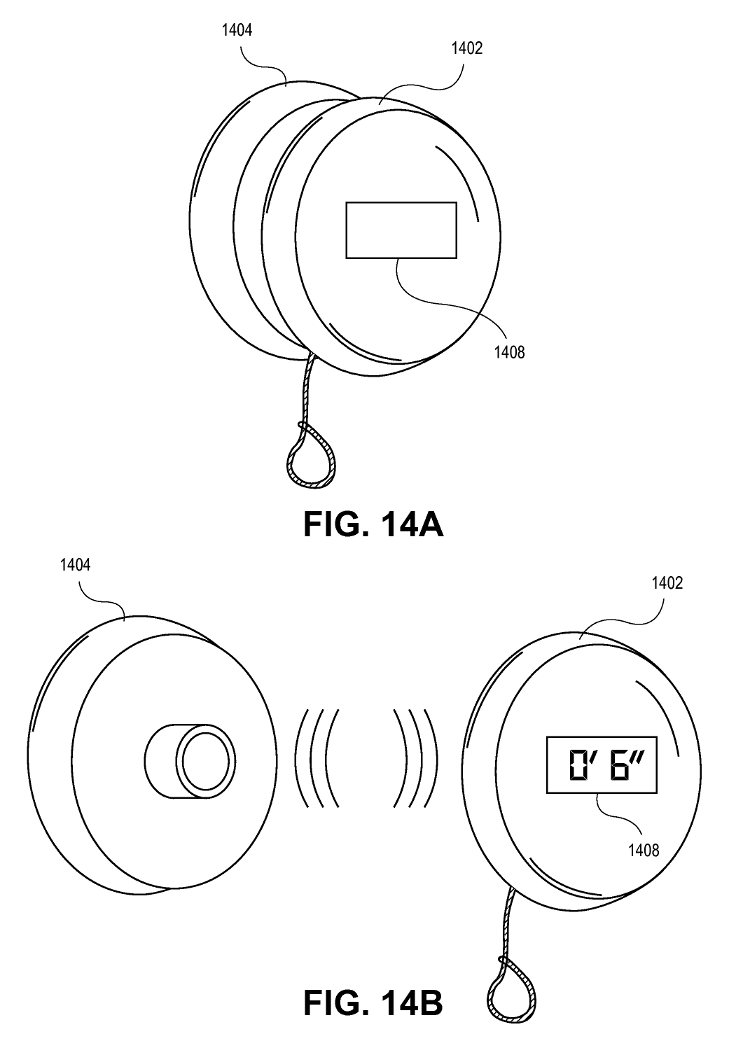

FIGS. 14A and 14B illustrate a yo-yo shaped measurement device. Portion 1404 can be separated from portion 1402, activating a transmitter, transponder, receiver, and display. Display 1408 indicates the distance between the two halves. Portion 1404 can include a suction cup, magnet, or other affixing device so that the assembly can be stored conveniently on a kitchen refrigerator. Other household items, such as letter openers, scissors, and keychains, can be similarly transformed into novelty measuring devices.

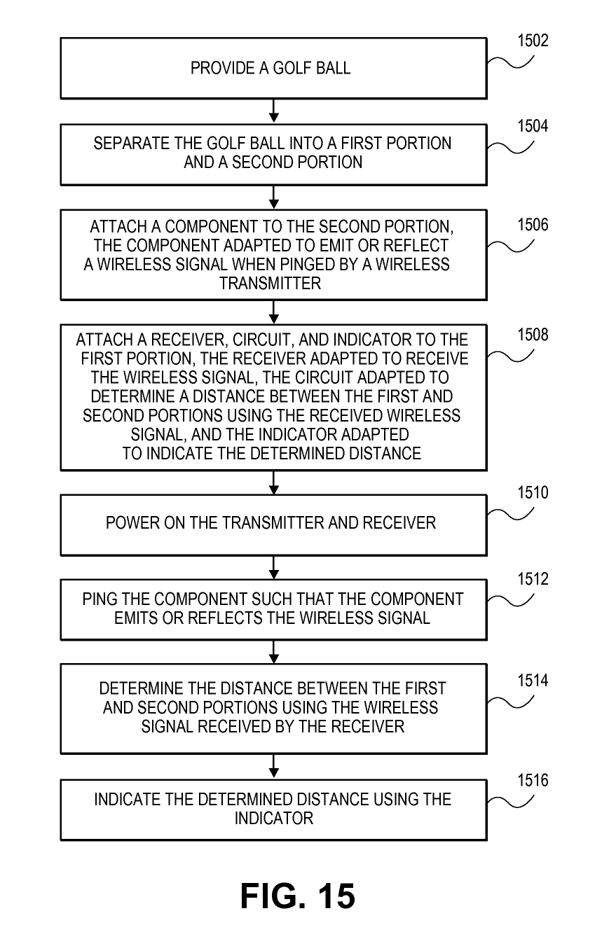

FIG. 15 is a flowchart illustrating a manufacturing process for a golf ball-shaped novelty measurement device in accordance with an embodiment. In operation 1502, a (new or used) golf ball is provided. In operation 1504, the golf ball is separated into a first portion and a second portion. The portions do not have to be equally sized. In operation 1506, a component is attached to the second portion, the component adapted to emit or reflect a wireless signal when pinged by a wireless transmitter. As an example of emitting, a transponder can emit an entirely different signal from an incoming ping signal. As an example of reflecting, a radio frequency identification (RFID) chip can alter and reflect the incoming waveform in order to encode it. In operation 1508, a receiver, circuit, and indicator are attached to the first portion. The receiver is adapted to receive the wireless signal, the circuit is adapted to determine a distance between the first and second portions using the received wireless signal, and the indicator is adapted to indicate the determined distance.

Further operations as shown in the figure can be used for testing, calibrating, and/or using the device. In operation 1510, the transmitter and receiver are powered on. In operation 1512, the transmitter is used to ping the component in the second portion such that the component emits or reflects the wireless signal. In operation 1514, the distance between the first and second portions using the wireless signal received by the receiver is calculated or otherwise determined. In operation 1516, the determined distance is indicated using the indicator. For example, the distance is displayed on an LCD display or read aloud by a speaker.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

What is claimed is:

1. A novelty measurement apparatus, comprising:
a first partial sphere housing;
a second partial sphere housing;
means for releasably coupling the first to the second housing such that a coupled assembly of the partial sphere housings forms a sphere;
a wireless receiver coupled to the first housing, the receiver adapted to receive a wireless signal from the second housing; and
a circuit operatively coupled to the receiver, the circuit adapted to determine a distance between the first and second housings using the wireless signal.

2. The apparatus of claim 1 wherein a diameter of the coupled assembly sphere is approximately 40 millimeters, thereby approximating a size of a golf ball.

3. The apparatus of claim 1 wherein the housings include dimples thereby simulating in appearance a golf ball.

4. The apparatus of claim 1 further comprising:
a display adapted to display the determined distance or a speaker adapted to audibly speak the determined distance.

5. The apparatus of claim 1 further comprising:
an indicator adapted to indicate whether the distance is shorter or longer than a previously determined distance.

6. The apparatus of claim 1 further comprising:
a transmitter coupled to the first housing, the transmitter enabled to transmit a wireless signal,
wherein the circuit is enabled to determine the distance by measuring a time delay between the signal transmitted from the transmitter and a received signal from the second housing.

7. The apparatus of claim 1 further comprising:
a transmitter coupled to the second housing, the transmitter enabled to transmit a wireless signal,
wherein the circuit is enabled to determine the distance by measuring an intensity of a signal received from the transmitter by the receiver.

8. The apparatus of claim 1 further comprising:
a switch operatively coupled to the circuit, the switch adapted to activate the circuit when the first and second housings are de-coupled from each other.

9. The apparatus of claim 1 wherein the means for releasable coupling the first to the second housing is electrically connected to the circuit and is operative to receive the wireless signal, thereby serving as an antenna.

10. The apparatus of claim 1 wherein the means for releasably coupling the first to the second housing comprises a mechanism selected from the group consisting of:
a threaded shaft and nut;
a pin and cushion;
a suction cup and smooth surface;
a snap;
a magnet;
a bayonet mount;
pegs and recesses; and
hook and loop fasteners.

11. The apparatus of claim 1 wherein the wireless signal is at a radio frequency (RF) or an infrared (IR) frequency.

12. The apparatus of claim 1 wherein the wireless signal is in a format selected from the group consisting of a global position system (GPS) format, wireless universal serial bus (wireless USB) format, Institute of Electrical and Electronics Engineers (IEEE) 802.11 format, and a BLUETOOTH® format.

13. A golf ball-shaped novelty measurement apparatus, comprising:
a spherical housing, the housing having a first portion and a second portion, the first and second portions releasably coupled to each other;
a wireless receiver coupled to the first housing portion, the receiver adapted to receive a wireless signal from the second housing portion;
a circuit operatively coupled to the receiver, the circuit adapted to determine a distance between the first and second housing portions using the wireless signal; and
a display adapted to display the determined distance.

14. The apparatus of claim 13 wherein a diameter of the spherical housing is approximately 40 millimeters, thereby approximating a size of a golf ball.

15. The apparatus of claim 13 wherein the housing includes dimples thereby simulating in appearance a golf ball.

16. The apparatus of claim 13 wherein the spherical housing comprises a recycled golf ball.

17. A novelty measurement apparatus, comprising:
a barrel having a shape that is graspable in the hand of a person;
a cap adapted to releasably connect to the barrel;
a wireless receiver coupled to one of the barrel and cap, the receiver adapted to receive a wireless signal from the other one of the barrel and cap; and
a circuit operatively coupled to the receiver, the circuit adapted to determine a distance between the first and second housings using the wireless signal.

18. The apparatus of claim 17 further comprising:
a pen tip connected with the barrel, the pen tip adapted to apply ink to a surface.

19. The apparatus of claim 17 further comprising:
a clip connected with the cap.

20. The apparatus of claim 17 further comprising:
a display adapted to display the determined distance.
